(19) United States
(12) Patent Application Publication
(10) Pub. No.: US 2007/0262987 A1
(43) Pub. Date: Nov. 15, 2007

(54) Collision sensing apparatus, method and medium

(75) Inventors: Jeong-hwan Ahn, Suwon-si (KR); Do-kyoon Kim, Seoyngnami-si (KR); Kee-chang Lee, Yongin-si (KR); Se-yoon Tak, Yongin-si (KR); Vladislav Yurievich Aranov, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/715,390

(22) Filed: Mar. 8, 2007

(30) Foreign Application Priority Data
Mar. 8, 2006 (KR) 10-2006-0021954

(51) Int. Cl. G06T 17/00

(52) U.S. Cl. 345/424

(57) ABSTRACT

A collision sensing apparatus, method and medium are provided. The apparatus includes an image dividing unit to divide an image into a plurality of voxels, a searching unit to search for a voxel having a plurality of model primitives, among the plurality of voxels, and an examination unit to determine whether a collision occurs between two or more model primitives in the searched voxel.

### CROSS-REFERENCE TO RELATED APPLICATIONS

This application claims the priority of Korean Patent Application No. 10-2006-0021954, filed on Mar. 8, 2006 in the Korean Intellectual Property Office, the disclosure of which is incorporated herein in its entirety by reference.

### BACKGROUND

1. Field

One or more embodiments of the present invention relates to collision sensing, and more particularly, to an apparatus, method and medium for sensing in real time the collision between the background and an object or between objects in an image.

2. Description of the Related Art

In an electronic domain, such as in a video game, the background of an image and objects included in the image may collide. Such a collision is preferably sensed as soon as it occurs. For example, in the case of a three-dimensional (3D) racing game, when a car operated by a game user collides with another car, or a tree outside a race ground, the 3D racing game should sense the collision in real time to quickly adjust the user's point total, as an example.

Conventional collision sensing apparatuses and techniques search the whole image space to sense a collision between the background and an object, or between objects included in an image. Accordingly, it is difficult to quickly sense a collision in an image using a conventional collision sensing apparatus or technique.

### SUMMARY

One or more embodiments of the present invention provides an apparatus for sensing in real time a collision between the background of an image and an object or between objects included in an image.

One or more embodiments of the present invention also provides a method of sensing in real time a collision between the background of an image and an object or between objects included in an image.

One or more embodiments of the present invention also provides a computer readable medium having recorded thereon a computer program for executing a method of sensing in real time a collision between the background of an image and an object or between objects included in an image.

Additional aspects and/or advantages of the invention will be set forth in part in the description which follows and, in part, will be apparent from the description, or may be learned by practice of the invention.

To achieve at least the above and/or other aspects and advantages, embodiments of the present invention include an apparatus sensing a collision including an image dividing unit to divide an image into a plurality of voxels, a searching unit to search for a voxel having a plurality of model primitives, among the plurality of voxels, and an examination unit to determine whether a collision occurs between two or more model primitives in the searched voxel.

To achieve at least the above and/or other aspects and advantages, embodiments of the present invention include a method of sensing a collision including dividing an image into a plurality of voxels, searching for a voxel having a plurality of model primitives, among the plurality of voxels, and determining whether a collision occurs between two or more model primitives in the searched voxel.

To achieve at least the above and/or other aspects and advantages, embodiments of the present invention include a computer readable medium having recorded thereon a computer program for executing a method of sensing a collision including dividing an image into a plurality of voxels, searching for a voxel having a plurality of model primitives, among the plurality of voxels, and determining whether a collision occurs between two or more model primitives in the searched voxel.

To achieve at least the above and/or other aspects and advantages, embodiments of the present invention include a collision sensing method including dividing an image into a plurality of voxels, and determining whether a collision occurs between model primitives in a voxel having a plurality of model primitives.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a reference diagram for explaining a world, objects, and the background of an image, according to an embodiment of the present invention;

FIG. 2 is a block diagram of a collision sensing apparatus, according to an embodiment of the present invention;

FIGS. 3A through 3D are reference diagrams explaining a model primitive used by the apparatus of FIG. 2, according to an embodiment of the present invention;

FIGS. 4A through 4D are diagrams illustrating examples of the shape of a model primitive, according to embodiments of the present invention;

FIGS. 5A through 5B are reference diagrams explaining the most desirable shape of a model primitive, according to an embodiment of the present invention;

FIG. 6 is a detailed block diagram of a primitive generation unit illustrated in FIG. 2, according to an embodiment of the present invention;

FIGS. 7A through 7C are reference diagrams for explaining the operations of an image dividing unit and a searching unit illustrated in FIG. 2, according to embodiments of the present invention;

FIG. 8 is a flowchart illustrating a collision sensing method, according to an embodiment of the present invention; and

FIG. 9 is a detailed flowchart illustrating operation 830 of the method illustrated in FIG. 8, according to an embodiment of the present invention.

### DETAILED DESCRIPTION OF EMBODIMENTS

Hereinafter, a collision sensing apparatus, method and medium, according to one or more embodiments of the present invention will be described in detail with reference to the accompanying drawings. Reference will now be made in detail to the embodiments of the present invention, examples of which are illustrated in the accompanying drawings, wherein like reference numerals refer to the like elements throughout. The embodiments are described below to explain the present invention by referring to the figures.

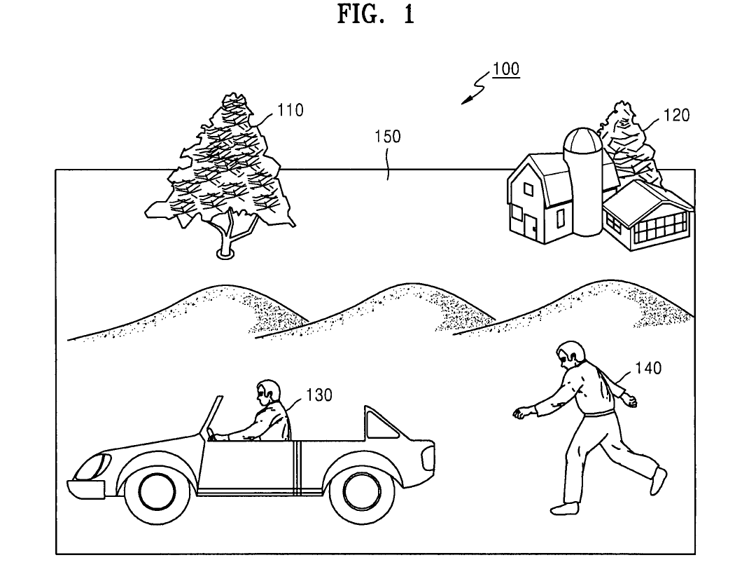

FIG. 1 is a reference diagram for explaining a world 100, including, for example, objects 110, 120, 130, and 140, and a background 150. In this disclosure, an image may be a still image or a moving picture comprising a plurality of frames. The world 100 is used as an example of an image in the following disclosure for convenience of explanation. However, other types of images having different types and quantities of objects and backgrounds may be used. Here, the world 100 is a frame at a specific time-point. The image may also be a two-dimensional (2D) image or a 3D image. In this disclosure, it is assumed that the image is a 3D image for convenience of explanation.

As illustrated in FIG. 1, the image may include objects 110 through 140 and the background 150, for example. Here, the objects 110 through 140 denote the images of bodies such as human beings, cars, etc., and the background 150 denotes the image of a place (e.g., a landscape, a river, a sea, the sky, etc.) in which the objects 110 through 140 may be located. In a strict sense, both a background and an object are bodies, but in this disclosure, the term “object” is used to indicate the images of various objects, not including the background.

In FIG. 1, the objects 110 and 120 are respectively a tree and a house, which are static objects, and the objects 130 and 140 are respectively a car and a human being, which are dynamic objects.

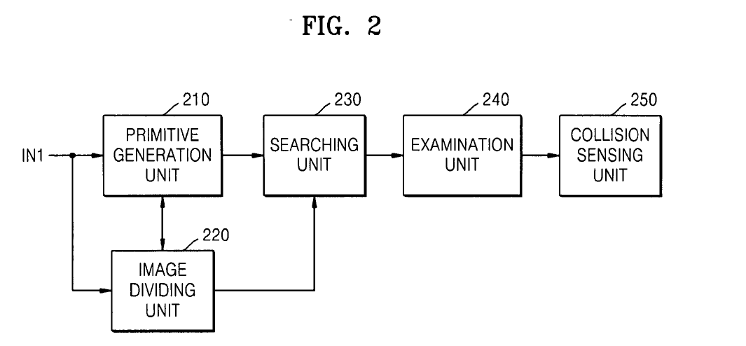

A collision may occur among the objects 110 through 140 or between the background 150 and one of the objects 110 through 140. Hereinafter, a principle of sensing a collision in the world 100 according to one or more embodiments of the present invention will be described in greater detail with reference to FIGS. 2 through 9.

FIG. 2 is a block diagram of a collision sensing apparatus according to an embodiment of the present invention. Referring to FIG. 2, the apparatus may include a primitive generation unit 210, an image dividing unit 220, a searching unit 230, an examination unit 240, and a collision sensing unit 250, for example.

The primitive generation unit 210 may generate a model primitive that is a primitive of a model included in a given image. Here, the primitive refers to an enveloping object. For example, ‘the primitive of K’ is an object that envelops K. In this case, the primitive may have a predetermined shape, and ‘the primitive of K’ may indicate an object having a minimum volume, among objects each having a predetermined shape, sufficient to envelope K.

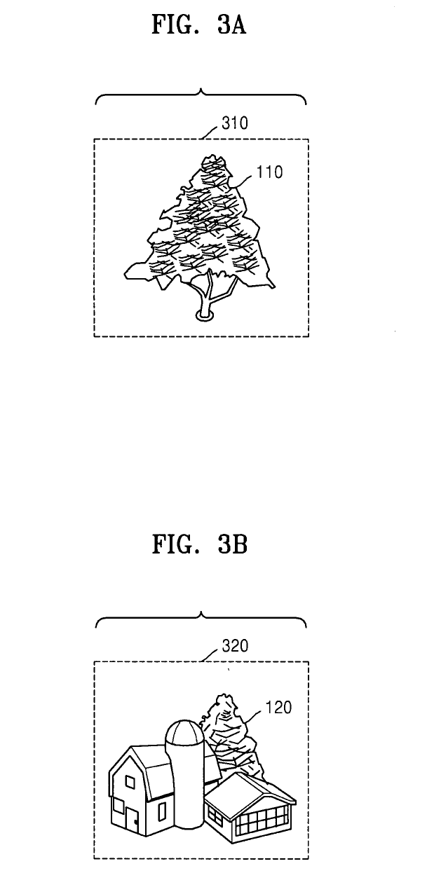

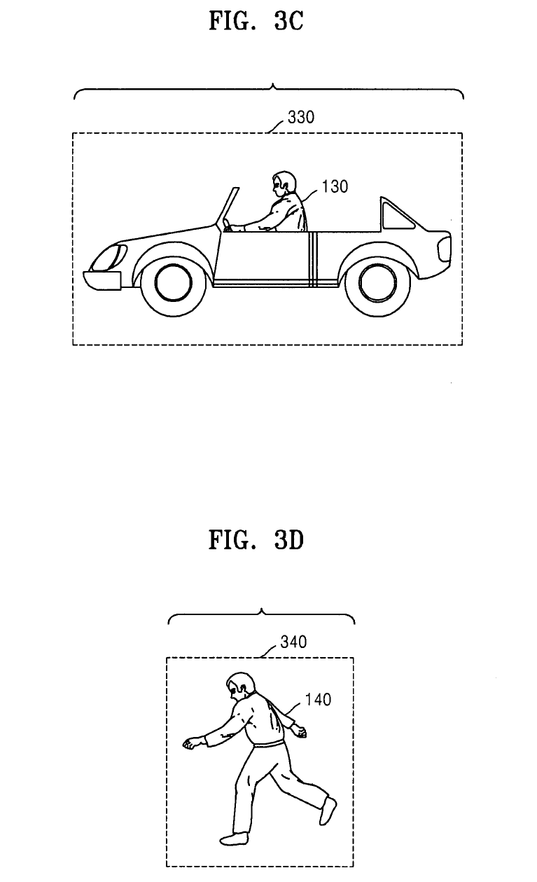

That is, the primitive generation unit 210 may generate a model primitive that envelops each of the models included in the given image, for example. Here, the model may indicate either a background or an object. Examples of the model primitive include a primitive of a background, i.e., an item enveloping the background (hereinafter referred to as a “background primitive”), and a primitive of an object, i.e., an item enveloping the object (hereinafter referred to as an “object primitive”). The image may be received via an input terminal IN 1, as an example. The operation of the primitive generation unit 210 will be described in greater detail with reference to FIGS. 3 through 6.

The image dividing unit 220 may divide the image into a plurality of voxels. Accordingly, the image has a voxel structure. The generated voxels may have the same size and volume, for example. In this case, the volume of each of the generated voxels is a value obtained by multiplying an average value of the volumes of all the model primitives generated by the primitive generation unit 210 by any predetermined value, e.g., 4.

The searching unit 230 may search for a voxel, from the obtained voxels, in which a collision is expected to occur between model primitives. Specifically, the searching unit 230 may search for a voxel having a plurality of model primitives among the obtained voxels. Here, the model primitive included in the voxel may be located completely within or partially within the model primitive.

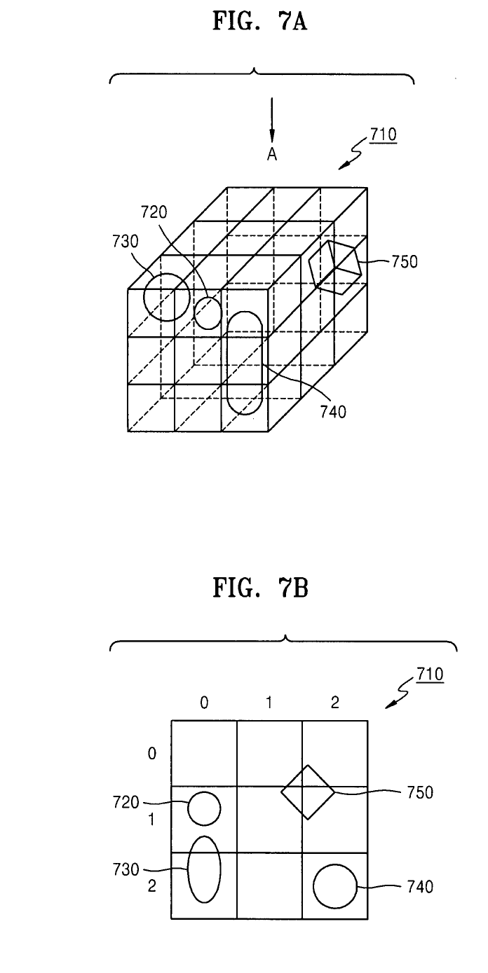

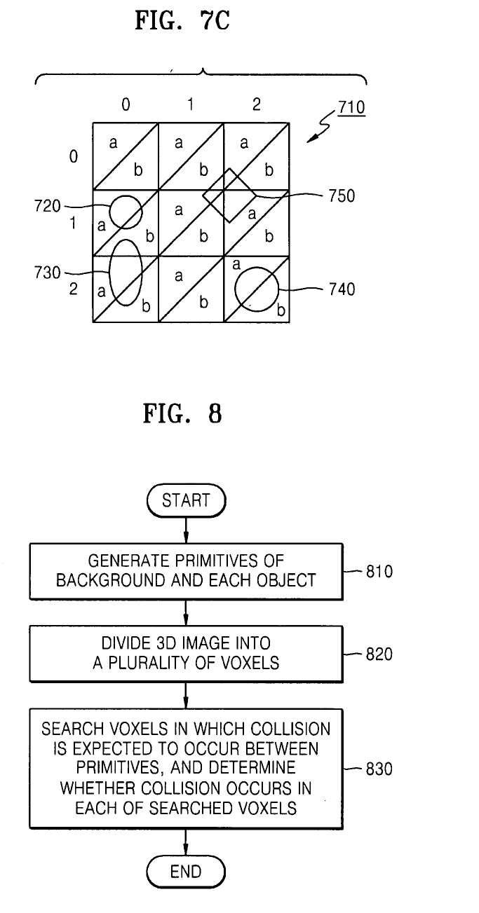

The operations of the image dividing unit 220 and the searching unit 230 will be described later in greater detail with reference to FIGS. 7A through 7C.

The examination unit 240 may determine whether a collision occurs between model primitives in each of the voxels searched by the searching unit 230. As an example, the examination unit 240 may determine whether a collision occurs using information regarding the locations of the model primitives. For example, when models a and b are included in the image and a model primitive a′ (a primitive of the model a) and a model primitive b′ (a primitive of the model b) belong to, i.e., are located within, the same voxel, the examination unit 240 may determine whether the model primitives a′ and b′ adjoin or overlap each other, based on the location information of the model primitives a′ and b′. In this case, if it is determined that the model primitives a′ and b′ adjoin or overlap each other, the examination unit 240 may determine that they collide. Otherwise, the examination unit 240 may determine that they do not collide.

The collision sensing unit 250 may sense a collision between the models in response to the determination result from the examination unit 240. Specifically, when the examination unit 240 determines that no collision occurs between the model primitives, the collision sensing unit 250 may sense that no collision occurs between the models. When the examination unit 240 determines that a collision occurs between the model primitives, the collision sensing unit 250 may sense that a collision occurs between the models.

The operations of the searching unit 230, the examination unit 240, and the collision sensing unit 250 have been described with respect to a model and a model primitive. Their operations will now be described with respect to a background (or an object) and a background primitive (or an object primitive).

In greater detail, in order to sense a collision between a background and an object, the searching unit 230, the examination unit 240, and the collision sensing unit 250 may operate as follows.

The searching unit 230 may search for at least one voxel having a background primitive and an object primitive among the voxels generated by the image dividing unit 220, for example.

In this case, the examination unit 240 may determine whether a collision occurs between a background primitive and an object primitive in each voxel searched by the searching unit 230. Also, the collision sensing unit 250 may sense a collision between the object and the background in response to the determination result from the examination unit 240. For example, if a background c and an object d are included in an image and a background primitive c′ (a primitive of the background c) and an object primitive d′ (a primitive of the object d) belong to the same voxel, the collision sensing unit 250 may sense that the object d collides with the background c when the examination unit 240 determines that the background primitive c′ collides with the object primitive d′.

In order to search for a collision between objects, the searching unit 230, the examination unit 240, and the collision sensing unit 250 may operate as follows.

The searching unit 230 may search for at least one voxel having a plurality of object primitives among the voxels generated by the image dividing unit 220, for example.

In this case, the examination unit 240 may determine whether a collision occurs between object primitives in each of the voxels searched with the searching unit 230. Also, the collision sensing unit 250 may sense a collision between objects in response to the determination result from the examination unit 240. For example, if an object e and an object f are included in the image and an object primitive e′ (a primitive of the object e) and an object primitive f′ (a primitive of the object 0 belong to the same voxel, the collision sensing unit 250 may sense that the objects e and f collide when the examination unit 240 determines that the object primitives e′ and f′ collide.

FIGS. 3A through 3D are reference diagrams for explaining a model primitive. Specifically, FIGS. 3A through 3D illustrate, as examples, object primitives 310, 320, 330, and 340 corresponding to the objects 110 through 140 illustrated in FIG. 1.

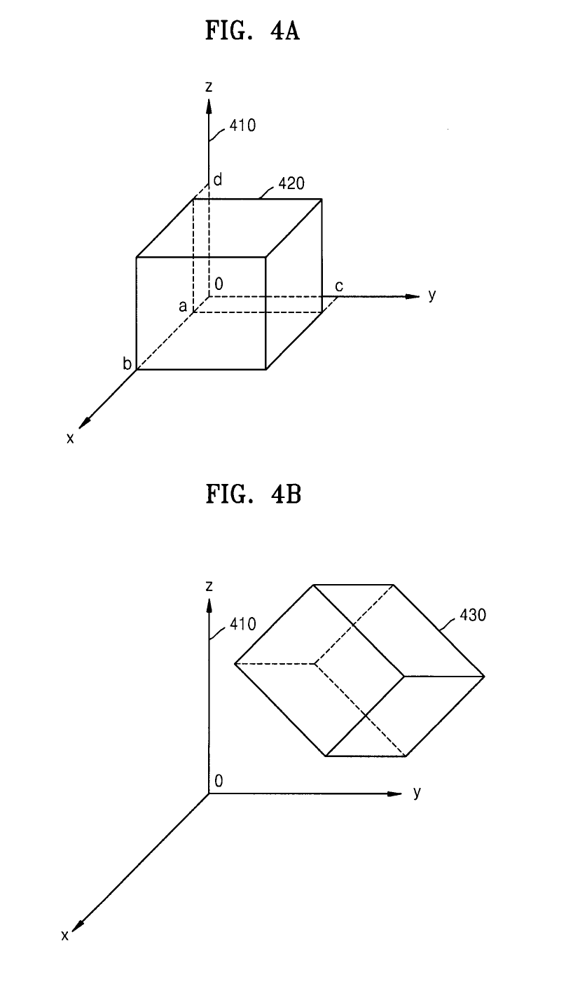

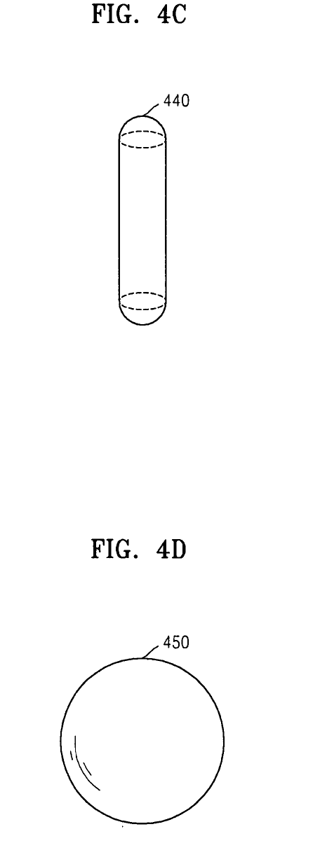

FIGS. 4A through 4D illustrate examples of a shape that a model primitive may have. That is, a model primitive may be formed in the shape of an axis aligned bounding box (AABB) 420 (see FIG. 4A, as an example), a shape of an oriented bounding box (OBB) 430 (see FIG. 4B, as an example), a shape of a capsule 440 (see FIG. 4C, as an example), and a shape of a sphere 450 (see FIG. 4D, as an example).

Here, the AABB indicates a hexahedron having three corners being parallel to orthogonal three-dimensional (3D) axes (x-axis, y-axis, and z-axis) 410, respectively. In an embodiment, the directions of the 3D axes 410 may be predetermined. The OBB is a hexahedron obtained by rotating the AABB by a predetermined angle (or by translating the AABB while rotating it by the predetermined angle) with respect to the 3D axes 410, for example.

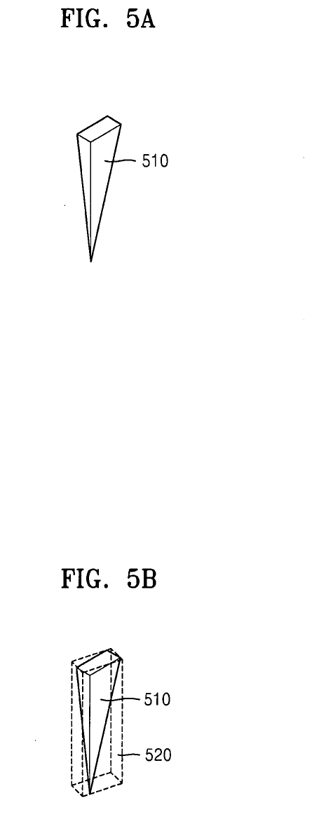

FIGS. 5A through 5C are reference diagrams to illustrate an example of a desirable shape for a model primitive. An object primitive 520 illustrated in FIG. 5B is more desirable as an object primitive of an object 510 illustrated in FIG. 5A than an object primitive 530 illustrated in FIG. 5C. That is, a desirable model primitive, in an embodiment, has a volume that most closely approximates the volume of the model.

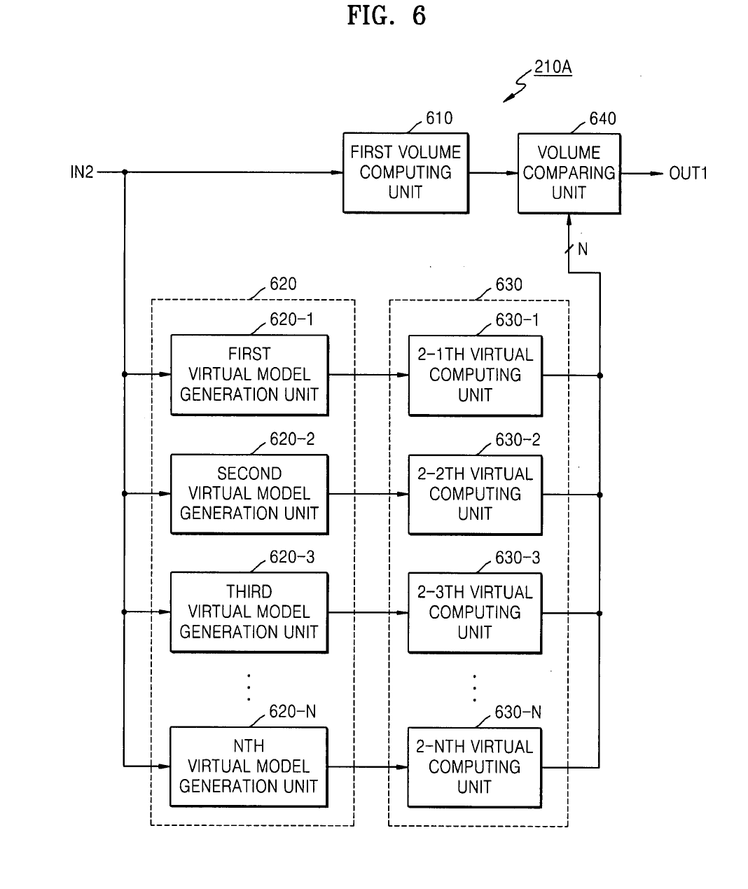

FIG. 6 is a detailed block diagram of the primitive generation unit 210 illustrated in FIG. 2 according to an embodiment of the present invention. Referring to FIG. 6, the primitive generation unit 210 may include a first volume computing unit 610, a virtual model generation unit 620, a second volume computing unit 630, and a volume comparing unit 640, for example. Here, an input terminal IN2 may be identical to the input terminal IN1 illustrated in FIG. 2.

The first volume computing unit 610 may compute the volume of a model included in a given image.

The virtual model generation unit 620 may include a first virtual model generation unit 620-1, a second virtual model generation unit 620-2, . . . , an N^{th} virtual model generation unit 620-N (N is an integer equal to or greater than 2). The virtual model generation unit 620 may generate first through N^{th} primitives. For example, an n^{th} virtual model generation unit 620-n generates an n^{th} primitive (n is a natural number less than or equal to N). Here, the n^{th} primitive may indicate a model primitive that is formed to an n^{th} predetermined shape to envelop a model.

An a^{th} primitive may be automatically generated, by an a^{th} virtual model generation unit 620-a from a b^{th} primitive generated by a b^{th} virtual model generation unit 620-b (a may be a natural number less than or equal to N, b may be a natural number less than or equal to N, and b≠a).

For example, assuming that the a^{th} primitive has a spherical shape and the b^{th} primitive has a shape of the AABB, the a^{th} primitive may be automatically generated from the b^{th} primitive by the a^{th} virtual model generation unit 620-a using the equation:

$${C}_{sp} = \frac{1}{2} ( V max + V min ) \\ r = ⌊ V max - {C}_{sp} ⌋ = \sqrt{{( {x}_{V max} - {x}_{Csp} )}^{2} + {( {y}_{V max} - {y}_{Csp} )}^{2} + {( {z}_{V max} - {z}_{Csp} )}^{2}} , \qquad ( 1 )$$

wherein Csp, Vmax, and Vmin denote vectors; and r, x_{Vmax}, y_{Vmax}, z_{Vmax}, x_{Csp}, y_{Csp}, and z_{Csp} denote scalars. In particular, Vmax denotes the largest vector among vectors representing the AABB. The vector Vmax indicates the largest vector among vectors representing AABB. For example, the Vmax may start from the origin, i.e., (x,y,z)=(0,0,0), and end at a point (x,y,z)=(b,0,0), (a,c,0), or (a,0,d). Similarly, Vmin indicates the smallest vector among vectors representing the AABB. For example, the Vmin starts from the original and ends at a point (x,y,z)=(a,0,0).

Csp is a vector starting from the original O and presenting the center of the a^{th} primitive; r denotes a radius of the a^{th} primitive; x_{Vmax}, y_{Vmax}, and z_{Vmax} denote the coordinates of the ending point of the vector Vmax that starts from the origin O; and x_{Csp}, y_{Csp}, and z_{Csp} denote the coordinates of the ending point of the vector Csp.

The second volume computing unit 630 may include a 2-1^{th} volume computing unit 630-1, a 2-2^{th} volume computing unit 630-2, . . . , and a 2-N^{th} volume computing unit 630-N, for example. The second volume computing unit 630 may compute the volumes of the first through n^{th} primitives. Specifically, the 2-n^{th} volume computing unit 630-n may compute the volume of the n^{th} primitive generated by the n^{th} virtual model generation unit 620-n.

The volume comparing unit 640 may compare the volume of the model computed by the first volume computing unit 610 with the volume of the n^{th} primitive computed by the second volume computing unit 630 in each of the first through N^{th} primitives, and may output the n^{th} primitive as a model primitive according to the N comparison results.

In detail, the volume comparing unit 640 may compute the difference between the volume of the model computed by the first volume computing unit 610 and the volume of the n^{th} primitive computed by the second volume computing unit 630, and may output the n^{th} primitive as a model primitive, via an output terminal OUT1, since the difference between the volume of the model and the volume of the n^{th} primitive is minimum among the N differences.

FIGS. 7A through 7C are reference diagrams for explaining the operations of the image dividing unit 220 and the searching unit 230 illustrated in FIG. 2 according to an embodiment of the present invention. Referring to FIG. 7A, an example image 710 given to the primitive generation unit 210 and the image dividing unit 220 may include four objects. The primitive generation unit 210 may generate object primitives 720, 730, 740, and 750 corresponding to these objects, and the image dividing unit 220 may divide the image 710 into 27 voxels, for example.

FIG. 7B illustrates the image 710 of FIG. 7A captured at a viewpoint marked by the arrow A illustrated in FIG. 7A. In FIG. 7B, the reference numerals 0, 1, and 2 are merely indexes given for convenience of explanation. Thus, it is possible to set the coordinates of each voxel using the given indexes. Referring to FIG. 7B, an object primitive 720 is present in a voxel with coordinates (0,1); an object primitive 730 is present in a voxel with coordinates (0,1) and a voxel with coordinates (0,2); an object primitive 750 is present in a voxel with coordinates (1,0), a voxel with coordinates (2,0), a voxel with coordinates (1,1), and a voxel with coordinates (2,1); and an object primitive 740 is present in a voxel with coordinates (2,2). In this case, according to an embodiment of the present invention, in order to sense a collision between objects, the searching unit 230 may search for a voxel having a plurality of object primitives, e.g., the voxel with coordinates (0,1), among all the voxels. That is, according to an embodiment of the present invention, whether a collision occurs between objects may be determined with respect to at least one voxel of an image, not all voxels thereof.

Likewise, according to an embodiment of the present invention, whether a collision occurs between a background and an object may be determined with respect to at least one voxel of the image, not all the voxels thereof. However, since a background occupies a larger space in the image 710 than an object, whether a collision occurs between the background and an object may be determined in a unit smaller than a voxel. That is, indexes may be allocated in units of voxels as illustrated in FIG. 7B or in units of sub regions of voxels as illustrated in FIG. 7C. Referring to FIG. 7C, according to an embodiment of the present invention, if a background is present in the image 710 of FIG. 7B, in order to determine whether a collision occurs between an object and the background, the searching unit 230 may search for a voxel with coordinates (0,1,a), a voxel with coordinates (0,1,b), a voxel with coordinates (0,2,a), a voxel with coordinates (0,2,b), a voxel with coordinates (1,0,b), a voxel with coordinates (1,1,a), a voxel with coordinates (1,1,b), a voxel with coordinates (2,1,a), a voxel with coordinates (2,1,b), a voxel with coordinates (2,2,a), and a voxel with coordinates (2,2,b), as voxels having an object positive and a background positive, among all the voxels.

FIG. 8 is a flowchart illustrating a collision sensing method according to an embodiment of the present invention. Referring to FIG. 8, the method may include operations 810 through 830 sensing in real time a collision between a background and an object included in an image.

First, the primitive generation unit 210 may generate primitives of a background and objects included in a given image (810). That is, a background primitive and at least one object primitive may be generated in operation 810.

Next, the image dividing unit 220 may divide the image into a plurality of voxels (820).

After operations 810 and 820, the searching unit 230 may search for voxels having a plurality of model primitives, among all the voxels generated in operation 820. The examination unit 240 may determine whether a collision occurs between model primitives in the searched voxels, and the collision sensing unit 250 may sense that a collision occurs between models when the examination unit 240 determines that a collision occurs between the model primitives (830).

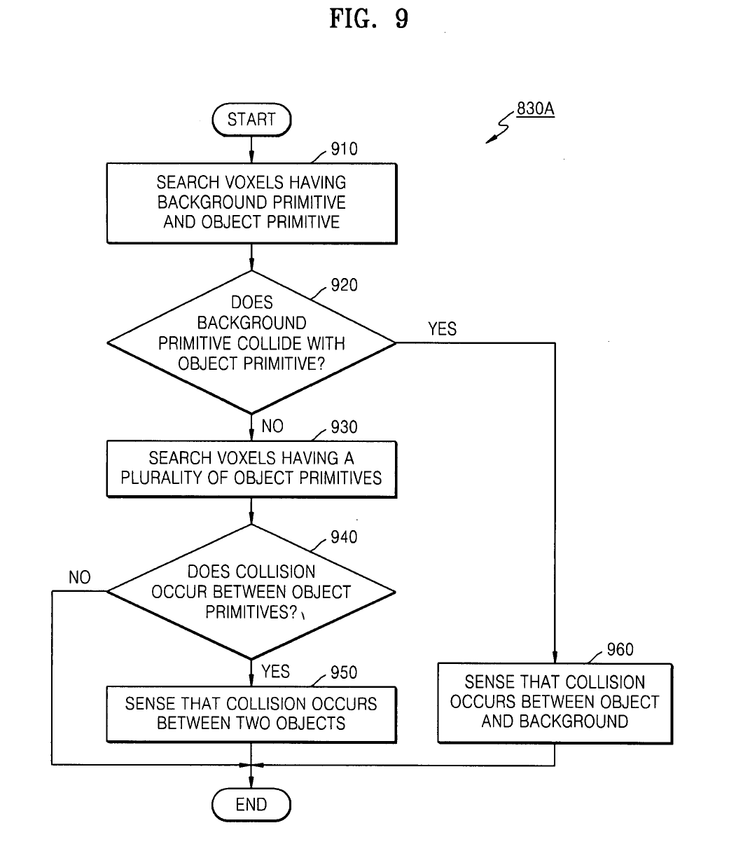

FIG. 9 is a detailed flowchart illustrating operation 830 of FIG. 8 according to an embodiment of the present invention. Referring to FIG. 9, operation 830 includes operations 910 through 960 determining whether a collision occurs between model primitives for each voxel having a plurality of model primitives, and sensing that a collision occurs between models.

In operation 910, the searching unit 910 may search for a voxel having a background primitive and an object primitive, from all the voxels generates in operation 820.

In operation 920, the examination unit 240 may determine whether a background primitive and an object primitive collide, in the voxel searched in operation 910.

In operation 930, if it is determined in operation 920 that a background primitive and an object primitive do not collide, the searching unit 910 may search for a voxel having a plurality of object primitives, from all the voxels generated in operation 820.

In operation 940, the examination unit 240 may determine whether a collision occurs between object primitives in the voxels searched in operation 930.

In operation 950, If it is determined in operation 940 that a collision occurs, the collision sensing unit 250 may sense that a collision occurs between objects in the voxels searched in operation 930.

In operation 960, If it is determined in operation 920 that a background primitive and an object primitive collide, the collision sensing unit 250 may sense that an object collides with the background in the voxels searched in operation 910.

In addition to this discussion, embodiments of the present invention may also be implemented through computer readable code/instructions in/on a medium, e.g., a computer readable medium, to control at least one processing element to implement any above described embodiment. The medium may correspond to any medium/media permitting the storing and/or transmission of the computer readable code.

The computer readable code may be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only a example, the processing element could include a processor or a computer processor, and processing elements may be distributed and/or included in a single device.

As described above, in a collision sensing apparatus, method and medium according to one or more embodiments of the present invention, only a part of the image, in which a collision is expected to occur, is explored to determine whether a collision occurs between a background and an object included in an image, thereby allowing the real time sensing of collisions. Also, it is possible to quickly sense a collision between a background (or an object) and an object, included in an image, by comparing the locations of a background primitive (or an object primitive) and an object primitive with each other, rather than comparing the locations of the background (or the object) and the object themselves. Further, one of various bodies enveloping a background (or an object), which has a volume that approximates the closest the volume of the background (or the object), is automatically selected as a background primitive (or an object primitive), thereby easily creating the background primitive (or the object primitive).

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus sensing a collision, comprising:
an image dividing unit to divide an image into a plurality of voxels;
a searching unit to search for a voxel having a plurality of model primitives, among the plurality of voxels; and
an examination unit to determine whether a collision occurs between two or more model primitives in the searched voxel.

2. The apparatus of claim 1, further comprising models included in the image, the models comprising a background and at least one object.

3. The apparatus of claim 1, further comprising a primitive generation unit to generate a model primitive that envelops each of a model included in the image.

4. The apparatus of claim 3, further comprising a collision sensing unit to sense that a collision occurs between two or more models when it is determined that the collision between two or more model primitives occurs.

5. The apparatus of claim 4, wherein the primitive generation unit generates a background primitive enveloping a background, and an object primitive enveloping at least one object,
the searching unit searches for voxels having the background primitive and at least one object primitive corresponding to the at least one object,
the examination unit determines whether the background primitive collides with the at least one object primitive in the searched voxel, and
the collision sensing unit senses that a collision occurs between the at least one object and the background, in response to an examination result.

6. The apparatus of claim 4, wherein the primitive generation unit generates an object primitive enveloping an object,
the searching unit searches for voxels having the object primitive from the generated voxels,
the examination unit determines whether the collision occurs between the object primitives in the searched voxel, and
the collision sensing unit senses that the collision occurs between at least one object in response to the examination result.

7. The apparatus of claim 3, wherein the primitive generation unit comprises:
a first volume computing unit computing a volume of the model;
a virtual model generation unit generating first through N^{th} primitives, where N is an integer equal to or greater than 2;
a second volume computing unit computing volumes of the first through N^{th} primitives; and
a volume comparing unit comparing the volume of the model computed by the first volume computing unit with the volume of an n^{th} primitive computed by the second volume computing unit in each of the first through N^{th} primitives, and outputting the n^{th} primitive as the model primitive corresponding to comparison results, where n is a natural number less than or equal to N,
wherein the n^{th} primitive has an n^{th} predetermined shape that envelopes the model.

8. The apparatus of claim 7, wherein the volume comparing unit computes a difference between the volume of the model computed by the first volume computing unit with the volume of the n^{th} primitive computed by the second volume computing unit in each of the first through N^{th} primitives, and outputs the n^{th} primitive as the model primitive when the difference between the volume of the model and the volume of the n^{th} primitive is minimum among N differences.

9. The apparatus of claim 3, wherein a volume of each of the voxels is computed by multiplying an average value of volumes of all the model primitives by a predetermined value.

10. The apparatus of claim 1, wherein the model primitives present in the searched voxel is located in whole or in part within the searched voxel.

11. The apparatus of claim 1, wherein the image is a three-dimensional image.

12. The apparatus of claim 1, wherein each of the model primitives is formed to have at least one of a shape of an axis aligned bounding box, an oriented bounding box, a capsule, and a sphere.

13. A method of sensing a collision, comprising:
dividing an image into a plurality of voxels;
searching for a voxel having a plurality of model primitives, among the plurality of voxels; and
determining whether a collision occurs between two or more model primitives in the searched voxel.

14. The method of claim 13, further comprising models included in the image, the models comprising a background and at least one object.

15. The method of claim 13, further comprising generating a model primitive that envelops each of a model included in the image.

16. The method of claim 13, further comprising sensing that a collision occurs between the models when it is determined that the collision between two or more model primitives occurs.

17. The method of claim 15, wherein the generating comprises generating a background primitive enveloping the background and an object primitive enveloping each object.

18. The method of claim 15, wherein
the generating comprises generating a background primitive enveloping the background, and an object primitive enveloping an object,
the searching comprises searching for voxels having at least one of a background primitive and at least one object primitive corresponding to at least one object,
the determining comprises determining whether the background primitive collides with the at least one object primitive in the searched voxel, and further comprising
sensing that the at least one object collides with the background when it is determined that the background primitive collides with the at least one object primitive in the searched voxel.

19. The method of claim 15, wherein
the generating comprises generating an object primitive enveloping an object,
the searching comprises searching for the voxel having a plurality of object primitives among the generated voxels,
the determining comprises determining whether the collision occurs between the plurality of objective primitives in the searched voxel, and further comprising
sensing that a collision occurs between the at least one object when it is determined that the collision occurs between the plurality of object primitives in the searched voxel.

20. The method of claim 15, wherein the generating comprises:
computing a volume of the model;
generating an n^{th} primitive formed to an n^{th} predetermined shape to envelope the model, where n is a natural number less than or equal to N, and N is an integer equal to or greater than 2;
computing a volume of the n^{th} primitive; and
computing a difference between the volume of the model and the volume the n^{th} primitive; and
determining whether first through N^{th} primitives are generated, and when it is determined that the first through N^{th} primitives are generated, outputting the n^{th} primitive as the model primitive when the difference between the volume of the model and the volume of the n^{th} primitive is a minimal value among the differences obtained.

21. The method of claim 20, further comprising generating the n^{th} primitive formed to an n^{th} predetermined shape to envelope the model, when it is determined that the first through N^{th} primitives are not generated.

22. The method of claim 13, wherein a volume of each of the voxels is computed by multiplying an average value of volumes of all the model primitives by a predetermined value.

23. The method of claim 13, wherein the model primitive present in the searched voxel is located in whole or in part within the searched voxel.

24. The method of claim 13, wherein the image is a three-dimensional image.

25. A computer readable medium having recorded thereon a computer program for executing a method of sensing a collision, the method comprising:
dividing an image into a plurality of voxels;
searching for a voxel having a plurality of model primitives, among the plurality of voxels; and
determining whether a collision occurs between two or more model primitives in the searched voxel.

26. The medium of claim 25, further comprising models included in the image, the models comprising a background and at least one object.

27. The medium of claim 25, further comprising generating a model primitive that envelops each of a model included in the image.

28. The medium of claim 25, further comprising sensing that a collision occurs between the models when it is determined that the collision between two or more model primitives occurs.

29. The medium of claim 27, wherein the generating comprises generating a background primitive enveloping the background and an object primitive enveloping each object.

30. The medium of claim 27, wherein
the generating comprises generating a background primitive enveloping the background, and an object primitive enveloping an object,
the searching comprises searching for voxels having at least one of a background primitive and at least one object primitive corresponding to the at least one object,
the determining comprises determining whether the background primitive collides with the at least one object primitive in the searched voxel, and further comprising
sensing that the at least one object collides with the background when it is determined that the background primitive collides with the at least one object primitive in the searched voxel.

31. The medium of claim 27, wherein
the generating comprises generating an object primitive enveloping a corresponding object,
the searching comprises searching for the voxel having a plurality of object primitives among the generated voxels,
the determining comprises determining whether the collision occurs between the plurality of objective primitives in the searched voxel, and further comprising
sensing that a collision occurs between the at least one object when it is determined that the collision occurs between the plurality of object primitives in the searched voxel.

32. The medium of claim 25, wherein the model primitive present in the searched voxel is located in whole or in part within the searched voxel.

33. A collision sensing method, comprising:
dividing an image into a plurality of voxels; and
determining whether a collision occurs between model primitives in a voxel having a plurality of model primitives.

34. The method of claim 33, wherein the model primitives comprise a background primitive enveloping a background of the image and an object primitive enveloping each object in the image.

35. The method of claim 33, further comprising determining that a collision occurs between models when it is determined that a collision occurs between model primitives.

36. The method of claim 33, further comprising searching for a voxel comprising two or more model primitives.

37. The method of claim 36, wherein the model primitive included in the searched voxel is located in whole or in part within the searched voxel.
